(19) United States
(12) Patent Application Publication
(10) Pub. No.: US 2015/0248427 A1
(43) Pub. Date: Sep. 3, 2015

(54) Method And Apparatus For Previewing File And Storage Medium

(71) Applicant: TENCENT TECHNOLOGY (SHENZHEN) COMPANY LIMITED, Shenzhen City (CN)

(72) Inventors: Anqi LI, Shenzhen City (CN); Guang YANG, Shenzhen City (CN); Qinghua ZHONG, Shenzhen City (CN); Xuan LUO, Shenzhen City (CN)

(21) Appl. No.: 14/712,958

(22) Filed: May 15, 2015

Related U.S. Application Data
(63) Continuation of application No. PCT/CN2013/083262, filed on Sep. 11, 2013.

(30) Foreign Application Priority Data
Nov. 15, 2012 (CN) 201210460321.0

(51) Int. Cl. G06F 17/30

(52) U.S. Cl. CPC G06F 17/30091; G06F 17/30126

(57) ABSTRACT

A method for previewing a file includes acquiring a directory to be displayed; extracting preview content of each file under the directory to be displayed; and displaying an index list for indexing each file under the directory to be displayed in a first area of a desktop, and displaying the preview content of at least one file under the directory to be displayed in a second area of the desktop.

### CROSS-REFERENCE TO RELATED APPLICATIONS

This application is a continuation of International Application No. PCT/CN2013/083262, filed Sep. 11, 2013. This application claims the benefit and priority of Chinese Application No. 201210460321.0, filed Nov. 15, 2012. The entire disclosures of each of the above applications are incorporated herein by reference.

### FIELD

The present disclosure relates to a method and an apparatus for previewing a file and a storage medium.

### BACKGROUND

This section provides background information related to the present disclosure which is not necessarily prior art.

A computer desktop with an operating system can distinguish files of different types, such as pictures, documents, and videos, in various grids of the desktop as shown in FIG. 1. Files are presented in forms of icons and shortcuts on the desktop. If a user wants to know specific content of a file, the user typically clicks on a corresponding file icon to open the file through a client window or magnifies a picture icon, both of which consume time. The specific content of the file cannot be accessed quickly when searching the desktop and various file directories for a desired file, which is inconvenient for the user.

### SUMMARY

This section provides a general summary of the disclosure, and is not a comprehensive disclosure of its full scope or all of its features.

In view of the foregoing, it is desirable to provide a preview method and apparatus and a storage medium that can directly display files under any file directory on a desktop, so that a user can clearly preview the content of each file under any file directory without opening the file or magnifying a file icon, which omits tedious operations, so as to save time for the user when searching for desired files.

A method for previewing a file includes the following: acquiring a directory to be displayed; extracting preview content of each file under the directory to be displayed; and displaying an index list for indexing each file under the directory to be displayed in a first area of a desktop, and displaying the preview content of at least one file under the directory to be displayed in a second area of the desktop.

An apparatus for previewing a file includes an acquisition module configured to acquire a directory to be displayed; an extraction module, configured to extract preview content of each file under the directory to be displayed; and a display module, configured to display an index list for indexing each file under the directory to be displayed in a first area of a desktop and display the preview content of at least one file under the directory to be displayed in a second area of the desktop.

The method and apparatus for previewing a file can directly display the files under any file directory on the desktop so that the user can clearly preview the content of each file under any file directory without opening the file or magnifying the file icon, which saves time for the user when searching for the desired files and omits tedious operations.

Further areas of applicability will become apparent from the description provided herein. The description and specific examples in this summary are intended for purposes of illustration and are not intended to limit the scope of the present disclosure.

### DRAWINGS

The drawings described herein are for illustrative purposes of various embodiments and not all possible implementations, and are not intended to limit the scope of the present disclosure.

Detailed description is made as follows with reference to various embodiments and accompanying drawings, where:

FIG. 1 is a diagram of using a desktop grid to display a file;

FIG. 2 is a flowchart of a method for previewing a file according to various embodiments;

FIG. 3 is a diagram of desktop grids according to various embodiments;

FIG. 4 is a diagram of displaying a picture file in a second area according to various embodiments;

FIG. 5 is a diagram of displaying a document file in a second area according to various embodiments;

FIG. 6 is a diagram of displaying a video file in a second area according to various embodiments;

FIG. 7 is a block diagram of an apparatus for previewing a file according to various embodiments; and

FIG. 8 is a block diagram of an extraction module of the apparatus for previewing a file according to various embodiments.

Corresponding reference numerals indicate corresponding parts throughout the several views of the drawings.

### DETAILED DESCRIPTION

Example embodiments will now be described more fully with reference to the accompanying drawings.

To further explain the technical means used in the present disclosure for achieving the technical effects of the present disclosure, specific implementation manners, structures, features, and technical effects of the present disclosure are described in detail below with reference to the accompanying drawings and various embodiments.

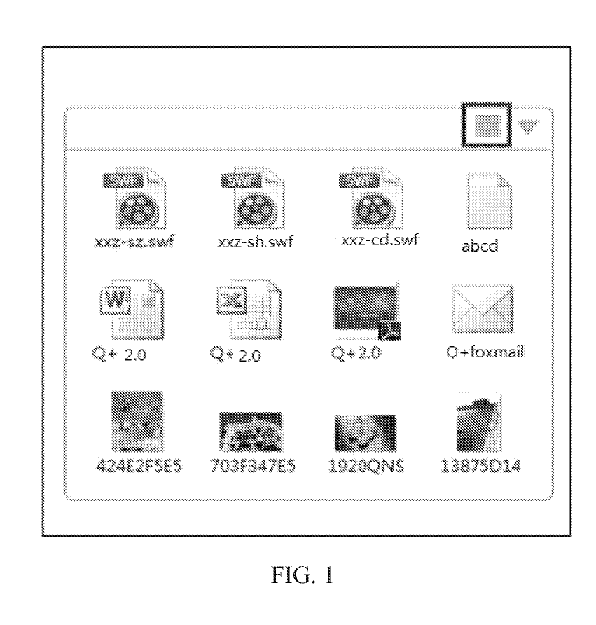

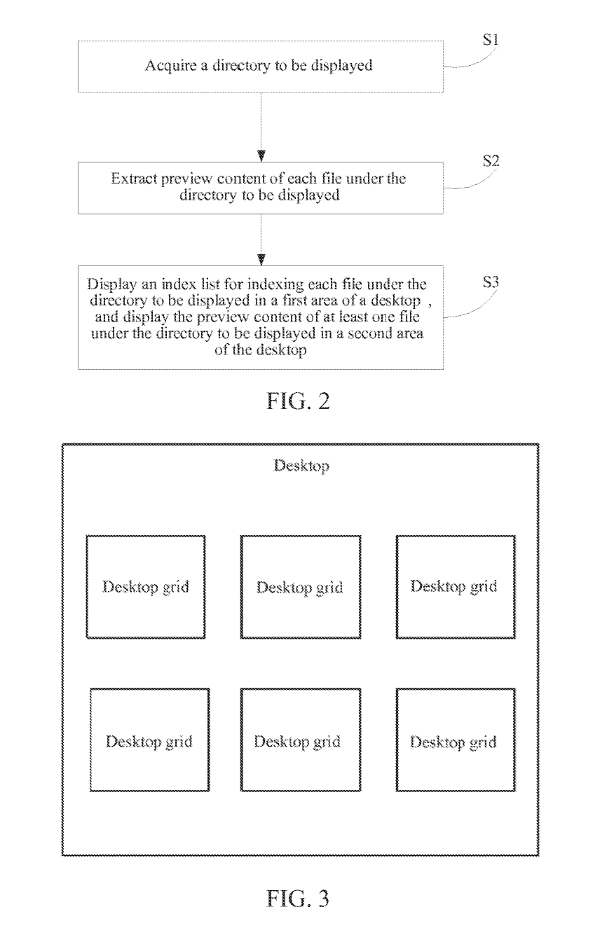

Referring to FIG. 1, various embodiments provide a method for previewing a file, including following.

S1: Acquire a directory to be displayed.

S2: Extract preview content of each file under the directory to be displayed.

S3: Display an index list for indexing each file under the directory to be displayed in a first area of a desktop and display the preview content of at least one file under the directory to be displayed in a second area of the desktop.

Detailed description is further made below with reference to various embodiments. The directory to be displayed in S1 may refer to the desktop or other storage paths of a computer which are designated by a user. The file under the directory to be displayed in S2 refers to, for example, a picture file (such as a TIF format file or a JPG format file), a document file (such as a Word document or a notepad document), or a video file (such as a wmv format file or an asf format file).

S2 may include S2.1 through S2.3:

S2.1: Determine storage paths of all files under the directory to be displayed in sequence, so as to find corresponding files in the storage paths. For example, a storage path of a file is D:\Translator2\icon\add.png, and the file with a name add.png can be found through the storage path.

S2.2: Parse each file and determine a type of the file. The type of the file includes, for example, a picture file, a document file, and a video file.

2.3: Extract the preview content of each file according to the type of the file, where if the file is a picture file, a thumbnail of the picture file is extracted, if the file is a document file, text content of the document file is extracted, and if the file is a video file, a multiple frames of images of the video file are extracted.

The first area in S3 includes several desktop grids and displays the index list for indexing each file under the directory to be displayed. The desktop grid refers to an independent block for dividing the desktop and bears the functions of arranging and displaying icons. Refer to a diagram of desktop grids shown in FIG. 3.

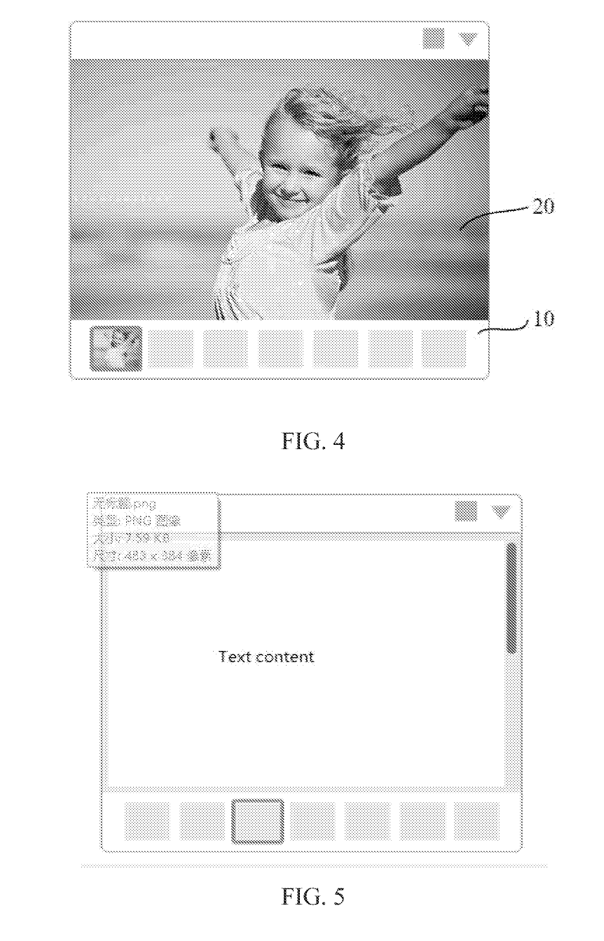

If the file is a picture file, the thumbnail of the extracted picture file is displayed in a corresponding desktop grid in the first area (a first area 10 as shown in FIG. 4). If the file is a document file, the text content of the extracted document file is displayed in a corresponding desktop grid in the first area in the form of a thumbnail. If the document file has more than one page, text content of one page (such as the first page) of the document file is displayed in a corresponding desktop grid in the first area in the form of a thumbnail, as shown in FIG. 5. If the file is a video file, one frame of image in the multiple frames of images of the extracted video file is displayed in a corresponding desktop grid in the first area in the form of a thumbnail. The one frame of image may a first frame of image of the video file or an image where the video file remains at the time of last pause, as shown in FIG. 6. If all files are displayed in the first area in the form of a thumbnail, the file index list is formed.

The second area includes a desktop grid. The size of the desktop grid in the second area is greater than the size of the desktop grid in the first area, so that the user can clearly see content of a file displayed in a desktop grid of the second area. The user may select a file by switching files one by one in the file index list displayed in the first area of the desktop, and display preview content of the selected file in the second area of the desktop. When the preview content of the file displayed in the second area of the desktop is selected, the file is demonstrated. Demonstrating the file may include the following three situations.

If the file is a picture file, the thumbnail of the extracted picture file is displayed in the second area of the desktop, such as a second area 20 as shown in FIG. 4. If the file is a document file, as shown in FIG. 5, the text content of the extracted document file is displayed in the second area of the desktop, and all text content can be browsed through a scroll bar. If the file is a video file, all frames of images in the multiple frames of images of the extracted video file are displayed in sequence in the second area of the desktop according to a certain time interval. All frames of images in the multiple frames of images of the video file are displayed quickly and in sequence, which is playing the video file.

The user may also set a playing control button in the second area of the desktop as shown in FIG. 6. After clicking on the playing control button, the user displays all the all frames of images in the multiple frames of images of the extracted video file in the second area of the desktop in sequence according to the certain time interval, so as to implement the function of controlling playing of the video file.

In addition, according to various embodiments, a video player may also be embedded in the second area. When the file is a video file, the video file is played through the set video player, so as to achieve the effect of previewing the video file on the desktop.

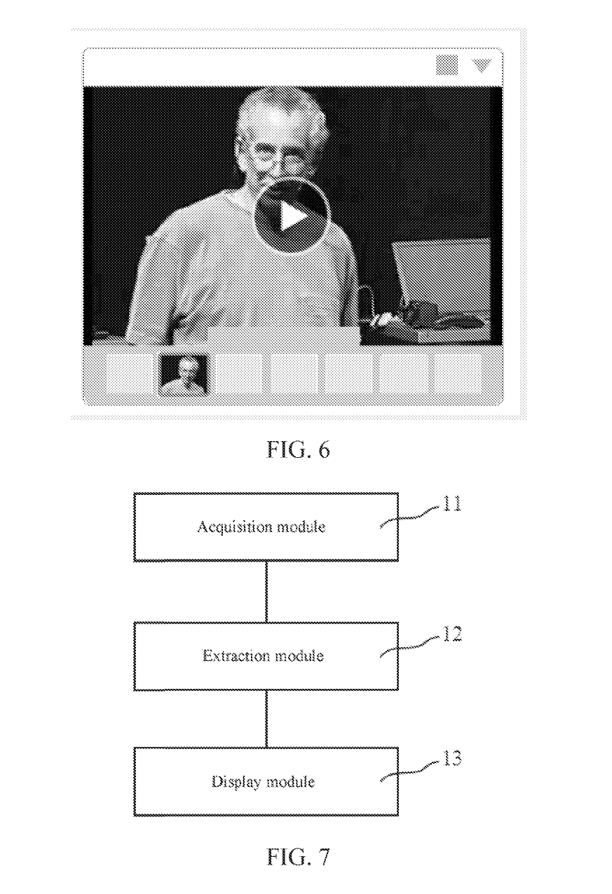

Referring to FIG. 7, various embodiments provide an apparatus 100 for previewing a file, including:

an acquisition module 11, configured to acquire a directory to be displayed;

an extraction module 12, configured to extract preview content of each file under the directory to be displayed; and

a display module 13, configured to display an index list for indexing each file under the directory to be displayed in a first area of a desktop, and display the preview content of at least one file under the directory to be displayed in a second area of the desktop.

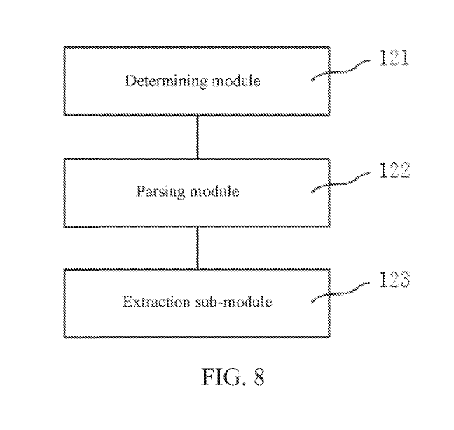

Referring to FIG. 8, the extraction module 12 includes:

a determining module 121, configured to determine storage paths of all files under the directory to be displayed in sequence, so as to find corresponding files in the storage paths;

a parsing module 122, configured to parse each file and determine a type of the file; and

an extraction sub-module 123, configured to extract the preview content of each file according to the type of the file, where if the file is a picture file, a thumbnail of the picture file is extracted, if the file is a document file, text content of the document file is extracted, and if the file is a video file, several frames of images of the video file are extracted.

The method for previewing a file according to various embodiments may be further referred to for processes of the foregoing modules, and the processes are not repeated herein.

Various embodiments of the present disclosure further provide a computer readable storage medium in which a computer executable instruction is stored. The computer readable storage medium is, for example, a nonvolatile memory, such as an optical disc, a hard disk, or a flash memory. The computer executable instruction is used for enabling a computer or a similar computing apparatus to complete the various operations in the forgoing method for previewing a file.

The above descriptions are preferred embodiments of the present disclosure, and are not intended to limit the present disclosure in any form. Although the present disclosure has been disclosed above through the preferred embodiments, the embodiments are not intended to limit the present disclosure. One with ordinary skill in the art can use the above disclosed technical content to make equivalent embodiments in which replacements or alterations are made without departing from the scope of the technical methods of the present disclosure. Any alteration, equivalent change or modification made to the above embodiments according to the technical essence of the present disclosure without departing from the content of the technical methods of the present disclosure shall fall within the scope of the technical methods of the present disclosure.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

What is claimed is:

1. A method for previewing a file, comprising the following steps:
acquiring a directory to be displayed;
extracting preview content of each file under the directory to be displayed; and
displaying an index list for indexing each file under the directory to be displayed in a first area of a desktop, and displaying the preview content of at least one file under the directory to be displayed in a second area of the desktop.

2. The method for previewing a file according to claim 1, wherein a file is selected by switching files one by one in the index list displayed in the first area of the desktop.

3. The method for previewing a file according to claim 2, wherein preview content of the selected file is displayed in the second area of the desktop.

4. The method for previewing a file according to claim 1, wherein the selected file is demonstrated when the preview content of the selected file displayed in the second area of the desktop is selected.

5. The method for previewing a file according to claim 4, wherein the step of extracting the preview content of each file under the directory to be displayed comprises:
determining storage paths of all files under the directory to be displayed in sequence, so as to find corresponding files in the storage paths;
parsing each file, and determining a type of the file; and
extracting the preview content of each file according to the type of the file.

6. The method for previewing a file according to claim 5, wherein the type of the file comprises at least one of the following: a picture file, a document file, and a video file.

7. The method for previewing a file according to claim 6, wherein the step of extracting the preview content of each file according to the type of the file comprises:
if the file is a picture file, extracting a thumbnail of the picture file;
if the file is a document file, extracting text content of the document file; and
if the file is a video file, extracting a specified number of frames of images of the video file.

8. The method for previewing a file according to claim 7, wherein the step of displaying the file index list for indexing each file under the directory to be displayed in the first area of the desktop comprises:
if the file is a picture file, displaying the thumbnail of the extracted picture file in the first area of the desktop;
if the file is a document file, displaying the text content of the extracted document file in the first area of the desktop in a form of a thumbnail; and
if the file is a video file, displaying one frame of image in the multiple frames of images of the extracted video file in the first area of the desktop in the form of a thumbnail.

9. The method for previewing a file according to claim 7, wherein the step of demonstrating the selected file when the preview content of the selected file displayed in the second area of the desktop is selected comprises:
if the file is a picture file, displaying the thumbnail of the extracted picture file in the second area of the desktop;
If the file is a document file, displaying the text content of the extracted document file in the second area of the desktop, and browsing all text content through a scroll bar; and
if the file is a video file, displaying all frames of images in the multiple frames of images of the extracted video file in sequence in the second area of the desktop according to a certain time interval.

10. An apparatus for previewing a file, comprising:
an acquisition module, configured to acquire a directory to be displayed;
an extraction module, configured to extract preview content of each file under the directory to be displayed; and
a display module, configured to display an index list for indexing each file under the directory to be displayed in a first area of a desktop, and display the preview content of at least one file under the directory to be displayed in a second area of the desktop.

11. The apparatus for previewing a file according to claim 10, wherein a file is selected by switching files one by one in the index list displayed in the first area of the desktop.

12. The apparatus for previewing a file according to claim 11, wherein the display module displays preview content of the selected file in the second area of the desktop.

13. The apparatus for previewing a file according to claim 10, wherein the display module is further configured to demonstrate the file when the preview content of the file displayed in the second area of the desktop is selected.

14. The apparatus for previewing a file according to claim 13, wherein the extraction module comprises:
a determining module, configured to determine storage paths of all files under the directory to be displayed in sequence, so as to find corresponding files in the storage paths;
a parsing module, configured to parse each file and determine a type of the file; and
an extraction sub-module, configured to extract the preview content of each file according to the type of the file.

15. The apparatus for previewing a file according to claim 14, wherein the type of the file comprises at least one of the following: a picture file, a document file, and a video file.

16. The apparatus for previewing a file according to claim 15, wherein the extracting the preview content of each file according to the type of the file comprises:
if the file is a picture file, extracting a thumbnail of the picture file;
if the file is a document file, extracting text content of the document file; and
if the file is a video file, extracting a specified number of frames of images of the video file.

17. The apparatus for previewing a file according to claim 16, wherein the displaying the index list for indexing each file under the directory to be displayed in the first area of the desktop comprises:
if the file is a picture file, displaying the thumbnail of the extracted picture file in the first area of the desktop;
if the file is a document file, displaying the text content of the extracted document file in the first area of the desktop in a form of a thumbnail; and
if the file is a video file, displaying an image of the extracted video file in the first area of the desktop in the form of a thumbnail.

18. The apparatus for previewing a file according to claim 16, wherein the demonstrating the file when the preview content of the file displayed in the second area of the desktop is selected comprises:
if the file is a picture file, displaying the thumbnail of the extracted picture file in the second area of the desktop;
If the file is a document file, displaying the text content of the extracted document file in the second area of the desktop, and browsing all text content through a scroll bar; and
if the file is a video file, displaying all frames of images in the multiple frames of images of the extracted video file in sequence in the second area of the desktop according to a certain time interval.

19. A storage medium comprising a computer executable instruction, the computer executable instruction being used for executing a method for previewing a file when executed by a computer processor, and the method comprising:
acquiring a directory to be displayed;
extracting preview content of each file under the directory to be displayed; and
displaying an index list for indexing each file under the directory to be displayed in a first area of a desktop, and displaying the preview content of at least one file under the directory to be displayed in a second area of the desktop.
